(19) United States
(12) Patent Application Publication
(10) Pub. No.: US 2019/0330434 A1
(43) Pub. Date: Oct. 31, 2019

(54) METHODS FOR GRAFTING LIQUID CRYSTALLINE COATINGS ONTO POLYMER SURFACES

(71) Applicant: SABIC GLOBAL TECHNOLOGIES B.V., Bergen op Zoom (NL)

(72) Inventors: Fabio Di Lena, Bergen op Zoom (NL); Ramon Groote, Oisterwijk (NL); Nadia Grossiord, Eindhoven (NL); Ellen P.A. Heeswijk, Eindhoven (NL)

(21) Appl. No.: 16/473,795

(22) PCT Filed: Dec. 22, 2017
(86) PCT No.: PCT/IB2017/058379

§ 371 Date: Jun. 26, 2019

Related U.S. Application Data
(60) Provisional application No. 62/439,312, filed on Dec. 27, 2016.

(51) Int. Cl. C08J 7/18; C09K 19/38; B05D 3/06

(52) U.S. Cl. CPC C08J 7/18; C09K 19/3852; C09K 19/3861; B05D 3/067; B05D 1/26; C08J 2435/02; C08J 2369/00; C08J 2333/12; C08J 2355/02; C08J 2433/14

(57) ABSTRACT

Methods of grafting a liquid crystalline coating onto a substrate, and articles comprising a substrate with a liquid crystalline coating are disclosed. The liquid crystalline coatings can be formed by (a) applying a primer layer comprising a Type II photoinitiator to a surface of the substrate, then (b) applying a coating mixture that comprises one or more liquid crystalline monomers to the surface of the substrate, and then (c) irradiating the coating mixture to form the liquid crystalline coating. The coating mixture can further comprise a second amount of a Type II photoinitiator. The methods can be performed in open air, at room temperature, or at ambient pressure, and the resulting liquid crystalline coatings can exhibit improved adhesive properties to the substrate.

### CROSS-REFERENCE TO RELATED APPLICATION

This application claims the benefit of U.S. Provisional Patent Application Ser. No. 62/439,312 filed Dec. 27, 2016. The related application is incorporated herein in its entirety by reference.

### BACKGROUND

The present disclosure relates to methods for grafting liquid crystalline coatings onto substrates, and articles containing substrates having such liquid crystalline coatings. In particular, methods are described for photografting a plurality of liquid crystalline monomers onto a polymer surface at room temperature and pressure.

Liquid crystals (LCs) are used in a variety of applications due to the ease with which they respond to changes in the surroundings. Small changes in external conditions, such as a temperature change or a variation in the electric and magnetic fields in which they may be immersed, can trigger phase transitions in the LCs that cause significant changes in their macroscopic properties. Liquid crystal polymers (LCPs) combine these properties with the processability of macromolecules, but they can also be used as coatings. When an optical (i.e. light), thermal, electrical, chemical, or magnetic stimulus is applied to a LCP-based coating, changes take place that dramatically modify its characteristics and therefore affect its properties.

The phenomenon of peeling is observed with coatings that are physisorbed and not chemisorbed onto the substrate. Physisorption is known to result in poorer adhesion, since it does not involve a chemical linkage between the adsorbent and the adsorbate. However, the typical procedures for generating chemisorbed coatings are often complex processes that require two or more of the following: surface pre-activation; post-polymerization purification steps; long reaction times of up to a few hours; above ambient temperatures; high vacuum; controlled atmosphere; and specific equipment.

Thus, it would be desirable to identify new methods for grafting liquid crystalline coatings onto a substrate through chemisorption without such complex processes.

### BRIEF SUMMARY

The present disclosure relates to simple, versatile, and rapid methods for chemical binding of liquid crystalline polymer (LC) coatings to substrates that do not require surface pre-activation, can be conducted at room temperature and pressure, in open air, with or without a solvent, and with conventional equipment. The methods generate LCP-based coatings that are chemisorbed onto the surface of a substrate, yielding a durable functionalization. The reaction takes place via a photo-induced process in the presence of a Type II photoinitiator, which is able to react with the surface of the substrate to generate radicals that initiate the polymerization of liquid crystalline monomers constituting the coating formulation. The reaction results in a polymer matrix (i.e., the coating), which is covalently bonded to the substrate (chemisorption). The process does not require surface pre-activation, elaborate post-polymerization purification steps, long reaction times, temperatures above ambient temperature, high vacuum, a controlled atmosphere, or specific equipment.

Disclosed in various embodiments are methods of grafting a liquid crystalline coating onto a substrate, comprising: (a) applying a first primer layer comprising a Type II photoinitiator onto a first surface area of the substrate; (b) applying a first coating layer comprising at least one LC monomer onto the first surface area of the substrate; and (c) irradiating the first coating layer to form a first liquid crystalline layer, which can make up all or part of the liquid crystalline coating.

If desired, steps (a) and (b) can be repeated, so the liquid crystalline coating is built up of multiple layers. Each layer can be the same or different from the other layers. In particular embodiments, the liquid crystalline coating is built up of at least two liquid crystalline layers. The second layer can be formed by applying a second primer layer comprising a Type II photoinitiator onto the first liquid crystalline layer; applying a second coating layer comprising at least one liquid crystalline monomer onto the first liquid crystalline layer; and irradiating the second coating layer to form a second liquid crystalline layer. The liquid crystalline coating is then made up of the first and second liquid crystalline layers. The two primer layers can be made from the same priming solution, or different solutions. Similarly, the two coating layers can be made from the same coating mixture, or different coating mixtures.

These process steps can be performed while at one or both of room temperature and at ambient pressure. The process can be performed in open air or in an inert environment (for example, under nitrogen).

The at least one LC monomer can be from about 70 weight percent (wt %) to 100 wt %, or about 90 wt % to 100 wt % of the coating layer. In other embodiments, the coating layer can further comprise a second amount of Type II photoinitiator (i.e. in addition to the Type II photoinitiator present in the primer layer). The coating layer can comprise from about 1 wt % to about 10 wt % of the second photoinitiator (typically measured by the solids weight percentage in the coating mixture from which the coating layer is formed).

The coating layer is generally formed from a coating mixture, and both the coating layer and the coating mixture can be described in terms of monomers that are present within the coating mixture and used to form the coating layer. The coating layer can comprise at least one LC monomer having the structure of Formula (I) as further disclosed herein. The at least one LC monomer may be an LC acrylate monomer that has one or more terminal acrylate groups. The coating mixture can contain LC monomers that are monofunctional, bifunctional (for example, an LC monomer comprising 1 acrylate group), or polyfunctional (for example, an LC monomer comprising 2 or more acrylate groups). The coating mixture can also include chiral dopants. It is noted that, as used herein, the functionality of the LC monomers refers to the functionality during the polymerization whereby a monofunctional LC monomer is capable of reacting one time, thereby functioning as a chain stopper during the polymerization reaction; a bifunctional LC monomer is capable of reacting two times, thereby functioning essentially as a chain extender, linking two monomer units together; and a polyfunctional LC monomer is capable of reacting more than two times during the polymerization reaction and is thereby capable of crosslinking the polymerizing network.

In more specific embodiments, the coating mixture can comprise a plurality of LC monomers wherein each LC monomer is present in an amount from about 1 wt % to 100 wt % of the coating mixture, or from about 1 wt % to about 99 wt % of the coating mixture, or from about 1 wt % to about 50 wt % of the coating mixture (by solids). In specific embodiments, the coating mixture can comprise from about 1 wt % to about 5 wt % of a LC monomer having the structure of Formula (1), from about 10 wt % to about 30 wt % of a LC monomer having the structure of Formula (2), from about 20 wt % to about 40 wt % of a LC monomer having the structure of Formula (3), and from about 30 wt % to about 50 wt % of a LC monomer having the structure of Formula (4); all based on the total weight of the LC monomer (by solids).

The coating mixture/layer can have an isotropic to nematic phase transition temperature of between 0 degrees Celsius (° C.) and 250° C., or 10 to 200° C. or 40 to 60° C. In some embodiments, the coating mixture/layer maintains a nematic phase at room temperature.

The primer layer can be formed by dissolving a Type II photoinitiator in a solvent to form a priming solution. The Type II photoinitiator can be a benzophenone, a thioxanthone, a xanthone, or a quinone.

The primer layer can comprise from about 0.0025 grams to about 1 gram of the Type II photoinitiator per square centimeter of the first surface area of the substrate (i.e. the area of the substrate to be coated with the priming solution).

The coating mixture/layer can be irradiated by exposing the coating mixture/layer to ultraviolet (UV) radiation. In particular embodiments, the coating mixture is irradiated by exposing the coating layer to UV radiation through the substrate.

The substrate generally has a surface with abstractable hydrogen atoms. The substrate may be polymeric, such as a polycarbonate. The substrate can also be transparent to visible and ultraviolet radiation, and/or can be flexible as well. In particular embodiments, the substrate is a polycarbonate, polymethyl methacrylate, polyethylene terephthalate, or a polyolefin.

The resulting LC coating, after irradiation, can have an adhesion rating of GT-0 as measured by ASTM 3359 or ISO 2409:2007(E).

In preferred embodiments, there is no need for pre-activating the substrate surface, treating the surface of the substrate prior to applying the coating mixture, or post-polymerization purification steps.

Also disclosed are articles comprising a substrate having a liquid crystalline coating, wherein the liquid crystalline coating has an adhesion rating of GT-0 as measured by ASTM 3359 or ISO 2409:2007(E). The coating can comprise/be formed from at least one liquid crystalline monomer having the structure of one of Formulas (1)-(4).

In preferred embodiments, the liquid crystalline coating is formed by photografting a coating mixture comprising a plurality of liquid crystalline monomers onto the substrate using a Type II photoinitiator.

Also disclosed are methods of grafting a liquid crystalline polymers onto a substrate, comprising: (a) applying a first photoinitiator onto a first area of the substrate, wherein the first photoinitiator is a Type II photoinitiator; (b) applying a coating mixture comprising a second Type II photoinitiator and the plurality of liquid crystalline monomers onto the first area of the substrate; and (c) irradiating the coating mixture to form a liquid crystalline coating; wherein the liquid crystalline coating has an adhesion rating of GT-0 as measured by ASTM 3359 or ISO 2409:2007(E).

In preferred embodiments, the coating mixture is applied at room temperature, at ambient pressure, or in open air.

These and other non-limiting characteristics are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a flow chart illustrating an exemplary method of grafting a liquid crystalline coating onto a substrate according to the present disclosure.

FIG. 2 is a side cross-sectional view illustrating a primer layer and a coating layer that have been applied to a first surface area of a substrate according to the present disclosure.

FIG. 3 is a side cross-sectional view illustrating a coating layer being irradiated through the substrate to form a liquid crystalline coating, according to an exemplary embodiment of the present disclosure.

FIG. 4 is a side cross-sectional view illustrating a liquid crystalline coating on a substrate according to the present disclosure.

FIG. 5 is a side cross-sectional view illustrating the formation of a polymer matrix from the liquid crystalline monomers in the coating layer as irradiation proceeds.

FIG. 6 is a flow chart illustrating an exemplary method of forming a liquid crystalline coating on a substrate from two liquid crystalline layers.

FIG. 7 is a side cross-sectional view illustrating the method shown in FIG. 6, with a first liquid crystalline layer, a second primer layer, and a second coating layer that have been applied to a first surface area of a substrate according to the present disclosure.

### DETAILED DESCRIPTION

The present disclosure can be understood more readily by reference to the following detailed description of desired embodiments and the examples included therein. In the following specification and the claims which follow, reference will be made to a number of terms which shall be defined to have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. The materials, methods, and examples disclosed herein are illustrative only and not intended to be limiting. All cited patents, patent applications, and other references are incorporated herein by reference in their entirety. However, if a term in the present application contradicts or conflicts with a term in the incorporated reference, the term from the present application takes precedence over the conflicting term from the incorporated reference.

The singular forms “a,” “an,” and “the” include plural referents unless the context clearly dictates otherwise. The term “or” means “and/or” unless clearly indicated otherwise by context.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

Numerical values in the specification and claims of this application, particularly as they relate to polymers or polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values). The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about”, may not be limited to the precise value specified, in some cases. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9 to 1.1.

For the recitation of numeric ranges herein, each intervening number there between with the same degree of precision is explicitly contemplated. For example, for the range of 6 to 9, the numbers 7 and 8 are contemplated in addition to 6 and 9, and for the range 6.0 to 7.0, the number 6.0, 6.1, 6.2, 6.3, 6.4, 6.5, 6.6, 6.7, 6.8, 6.9, and 7.0 are explicitly contemplated.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, the aldehyde group —CHO is attached through the carbon of the carbonyl group.

The term “aliphatic” refers to a linear or branched array of atoms that is not aromatic. The backbone of an aliphatic group is composed exclusively of carbon. The aliphatic group can be substituted or unsubstituted. Exemplary aliphatic groups include, but are not limited to, methyl, ethyl, isopropyl, hexyl, and cyclohexyl.

The term “aromatic” refers to a radical having a ring system containing a delocalized conjugated pi system with a number of pi-electrons that obeys Hückel's Rule. The ring system can include heteroatoms such as nitrogen, sulfur, selenium, silicon and oxygen, or can be composed exclusively of carbon and hydrogen. Aromatic groups are not substituted. Exemplary aromatic groups include, but are not limited to, phenyl, pyridyl, furanyl, thienyl, naphthyl and biphenyl.

The term “ester” refers to a radical of the formula —CO—O—, wherein the carbon atom and the oxygen atom are both covalently bonded to carbon atoms.

The term “carbonate” refers to a radical of the formula —O—CO—O—, wherein the oxygen atoms are both covalently bonded to carbon atoms. A carbonate group is not an ester group, and an ester group is not a carbonate group.

The term “hydroxyl” refers to a radical of the formula —OH, wherein the oxygen atom is covalently bonded to a carbon atom.

The term “carboxy” or “carboxyl” refers to a radical of the formula —COOH, where the carbon atom is covalently bonded to another carbon atom. A carboxyl group can be considered as having a hydroxyl group, although a carboxyl group can participate in certain reactions differently from a hydroxyl group.

The term “anhydride” refers to a radical of the formula —CO—O—CO—, wherein the carbonyl carbon atoms are covalently bonded to other carbon atoms. An anhydride can be considered as being equivalent to two carboxyl groups.

The term “alkyl” refers to a radical composed entirely of carbon atoms and hydrogen atoms which is fully saturated. The alkyl radical may be linear, branched, or cyclic.

The term “amino” refers to a radical of the formula —NR₂, where each R is alkyl.

The term “halogen” refers to fluorine, chlorine, bromine, and iodine.

The term “alkoxy” refers to an alkyl radical which is attached to an oxygen atom, i.e. —O—CₙH₂ₙ₊₁.

The term “nitrile” refers to a radical of the formula —CN, wherein the carbon atom is covalently bonded to another carbon-containing group.

The term “acrylate group” refers to a radical of the formula CH₂═CH—CO—O—.

The term “substituted” refers to at least one hydrogen atom on the named radical being substituted with another functional group, such as halogen, —OH, —CN, or —NO₂. An exemplary substituted alkyl group is hydroxyethyl.

The term “copolymer” refers to a molecule derived from two or more structural units or monomeric species, as opposed to a homopolymer, which is a molecule derived from only one structural unit or monomer.

The term “polycarbonate” as used herein refers to a polymer comprising residues of one or more monomers, joined by carbonate linkages.

The term “crosslink” and its variants refer to the formation of a stable covalent bond between two oligomers/polymers. This term is intended to encompass the formation of covalent bonds that result in network formation, or the formation of covalent bonds that result in chain extension. The term “cross-linkable” refers to the ability of an oligomer/polymer to form such stable covalent bonds.

The present disclosure refers to “polymers.” A polymer is a substance made up of large molecules composed of multiple repeating units chained together, the repeating units being derived from a monomer. The term “polymer” can refer to the substance or to an individual large molecule in the substance, depending on the context. One characteristic of a polymer is that different molecules of the polymer will have different lengths, and the polymer is described as having a molecular weight that is based on the average value of the chains (e.g. weight-average or number-average molecular weight). The art also distinguishes between an “oligomer” and a “polymer”, with an oligomer having only a few repeating units, while a polymer has many repeating units. For purposes of this disclosure, the term “oligomer” refers to molecules having a weight-average molecular weight of less than 5,000 grams per mole (g/mol), and the term “polymer” refers to molecules having a weight-average molecular weight of 5,000 g/mol or more, as measured by GPC using polycarbonate molecular weight standards. These molecular weights are measured prior to any UV exposure.

The terms “room temperature” and “ambient temperature” refer to a temperature from about 20° C. to about 25° C. The terms “room pressure” and “ambient pressure” refer to an atmospheric pressure from about 95 kilopascal (kPa) to about 105 kPa. The term “open air” refers to air naturally found within the Earth's troposphere. Generally, open air comprises, by volume, about 78% nitrogen, about 21% oxygen, about 1% argon, about 0.04% carbon dioxide, and small amounts of other gases. Open air can further include from about 0.001 wt % to about 5 wt % of water vapor based on the total weight of the air.

Continuing now, the present disclosure relates to methods for forming a coating/layer on the surface of a substrate, wherein the coating/layer is formed from or contains a liquid crystalline polymer (LCP) to functionalize the surface of the substrate. LCP-based coatings are usually prepared by photopolymerizing LC monomers of the general Formula (I):

RHC═CHX Formula (I)

wherein R is hydrogen or an alkyl group, and X is a group containing a liquid crystal (LC) moiety. In some cases, the group X also contains at least another carbon-carbon double bond. As a result, the LC monomer can be either bifunctional or polyfunctional.

In conventional methods, these LC monomers are polymerized directly on the surface to be functionalized. The reaction takes place in the presence of a Type I photoinitiator that, under ultraviolet (UV) light, undergoes a homolytic bond cleavage, resulting in radicals that induce polymerization of the vinyl monomers of the LC monomers in the coating formulation. In these processes, the surface of the substrate does not take part in the polymerization, yielding a physisorbed coating.

However, LCP-based coatings are often plagued by peeling, or delamination, which consists of the premature detachment of the coating from the substrate, inducing a loss of the function the coating was designed to have, thus reducing its lifespan. This is particularly so for polymeric substrates. Thus, solving the problem of coating delamination is of paramount importance for having a durable functionalization.

The present disclosure relates to liquid crystalline (LC) coatings and methods of photografting one or more LC monomers onto a substrate. The LC coatings are prepared from a coating mixture comprising at least one LC monomer that is applied to a substrate to form a coating layer. More particularly, the LC coatings are prepared by irradiating (a) a primer layer comprising a Type II photoinitiator, which is applied directly to the substrate; and (b) a coating layer containing at least one LC monomer, which is applied upon the primer layer. When the primer layer and the coating layer are exposed to the appropriate wavelength and intensity of light, the Type II photoinitiator induces a reaction with the surface of the substrate and with the LC monomers, forming a liquid crystalline polymer matrix that is chemically attached to the substrate. The present disclosure also relates to articles comprising a substrate having such LC coatings made using the methods described herein. These articles can be useful in applications such as infrared reflectors, haptics, self-cleaning, sensors/biosensors, photochromics, displays, data storage, anticounterfeiting/security, optical films, robotics (e.g. controlling friction of the surface), and microfluidics.

Generally, the methods of the present disclosure include applying (a) a primer layer comprising a Type II photoinitiator, and (b) a coating layer comprising one or more LC monomers to a surface of a substrate, and then irradiating the coating layer with UV light to induce photopolymerization of the LC monomers. The operation of the Type II photoinitiator also induces radicals upon the surface of the substrate, which then participate in the polymerization process with the LC monomers. The LC coatings are thereby covalently bound (i.e. chemisorbed) to the surface of the substrate, and exhibit improved adhesion properties. Furthermore, the processes disclosed herein can be performed in open air, at room temperature, and at ambient pressure. The application and irradiation steps can be repeated with the same or different materials, such that the liquid crystalline coating is built up of one or more liquid crystalline layers.

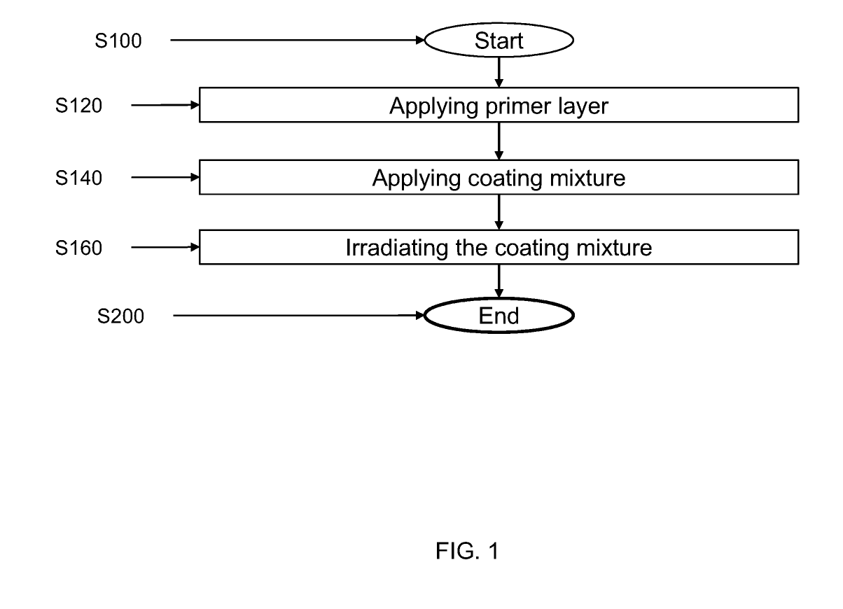

FIG. 1 illustrates an exemplary method of grafting a liquid crystalline coating onto a substrate according to one embodiment of the disclosure. The method begins at step S100.

At step S120, a primer layer is applied to a first surface area of a substrate. The primer layer comprises a Type II photoinitiator. In particular embodiments, the primer layer is first prepared by dissolving an amount of the Type II photoinitiator in a solvent to form a priming solution, which is then applied to the surface of the substrate that is to be grafted with the LC coating to form the primer layer. The priming solution can sit on the surface of the substrate for a period of time to allow the solvent to evaporate prior to applying any other layers or mixtures. This period of time may range from 10 seconds to about 1 hour, preferably about 30 seconds to about 30 minutes. Evaporation of the solvent can proceed at ambient conditions or with application of heat.

The primer layer can be applied to one or more different surfaces of the substrate, or to only a portion of a surface of the substrate, depending on the desired area to be grafted with the LC coating. The primer layer is applied directly to the substrate, with no intervening layers in between. In particular embodiments, the primer layer can be applied while at room temperature, at ambient pressure, or in open air.

At step S140, a coating mixture is applied to the first surface area of the substrate, or put another way upon the primer layer, to form the coating layer. As discussed further below, the coating mixture comprises at least one LC monomer. In particular embodiments, the coating mixture comprises a plurality of LC monomers. In specific embodiments, the coating mixture can further comprise a second amount of a Type II photoinitiator. The Type II photoinitiator in the coating mixture is generally the same as the Type II photoinitiator that is present in the primer layer.

The primer layer facilitates the bonding of the LC monomers in the coating layer to the surface of the substrate and promotes adhesion of the resulting LC coating layer. Thus, like the primer layer, the LC coating layer can also be applied to one or more surfaces of the substrate, or to only a portion of a surface of the substrate. In particular embodiments, the coating mixture can be applied while at room temperature, at ambient pressure, or in open air. Generally, however, the coating mixture should be applied at a temperature that is lower than the nematic-isotropic phase transition temperature (T_{NT}) of the coating mixture and higher than the crystal-nematic phase transition temperature (T_{CN}).

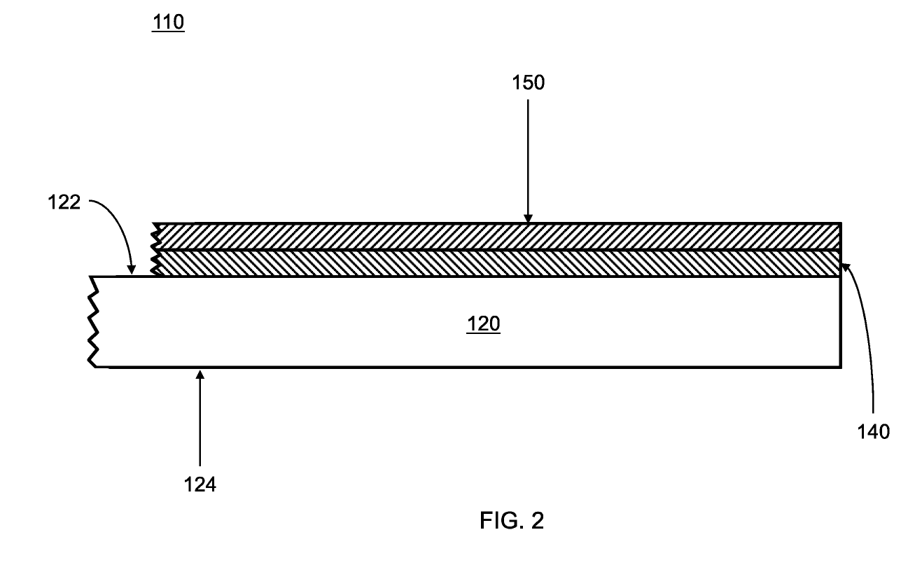

FIG. 2 is a side cross-sectional view illustrating a primer layer 140 and a coating layer 150 that have been applied to a first surface area 122 of a substrate 120, as described in steps S120 and S140. As seen here, the primer layer 140 is directly contacting the substrate 120, and the coating layer 150 is applied upon the primer layer 140. Generally, the substrate 120 can have at least a first surface with a first surface area 122 and a second surface 124 opposite the first surface, although the substrate 120 can be provided in many shapes and sizes. The article is indicated with reference numeral 110.

Referring back to FIG. 1, at step S160, the layers on the substrate (i.e. the primer layer and the coating layer) are irradiated to form the LC coating (i.e. the LC coating layer). The layers can be irradiated by exposure to ultraviolet (UV) light at an appropriate wavelength and in an appropriate dosage that brings about the desired amount of photopolymerization and crosslinking of the LC monomers for the given application. The irradiation should reach the substrate-coating interface, permitting the photoinitiator to cause the formation of covalent bonds between the substrate and the LC polymers formed during the irradiation.

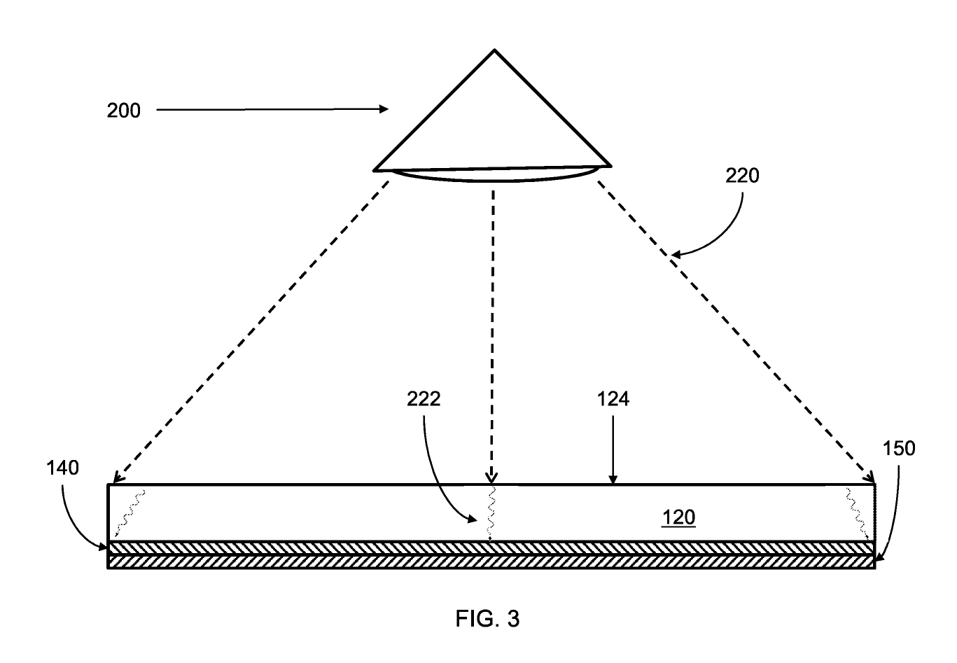

In particular embodiments, the coating layer and the primer layer are not directly exposed to UV light. Rather, in some embodiments, a second surface of the substrate is exposed to the UV light, and the coating layers are irradiated by UV light transmitted through the substrate. This is shown in FIG. 3, which is a side cross-sectional view illustrating step S160, wherein the primer layer 140 and the coating layer 150 are irradiated by a light source 200. The LC monomers in the coating layer 150 are photopolymerized by exposing the second surface 124 to UV light 220. In other words, the coating layer 150 is not directly exposed to UV light 220; rather, a surface 124 of the substrate 120 that is not covered by the coating layer 150 or primer layer 140 is exposed to UV light 220. The light transmitted through the substrate 222 causes the photoinitiator in the primer layer 140 and in the coating layer 150 to initiate polymerization of the LC monomers in the coating layer 150. Thus, the substrate 120 can be considered to be transparent to visible light/UV radiation. This also permits the irradiation to reach the substrate-coating interface.

The coated substrate can be taped onto a plate (e.g. glass) and placed in an irradiation chamber for UV irradiation. During the irradiation, the substrate can be placed upside-down (i.e. an uncoated side facing the light source, coated side adjacent the plate), or the coated side can face the light source. This can vary depending on the mixture itself.

In particular embodiments, the irradiation of the coated substrate is performed under a continuous nitrogen flow. The exposure time of the coating layer to the photoactivating radiation will be dependent on the application and the particular properties of the substrate (e.g. % light transmittance). In particular embodiments, the coating layer can be irradiated for from 1 second to about 1 hour, depending on the irradiation system.

The irradiation can be accomplished by using a UV-emitting light source such as a mercury vapor, High-Intensity Discharge (HID), or various UV lamps. For example, commercial UV lamps are sold for UV curing from manufacturers such as Excelitas Technologies (for example, the OMNICURE™ LX500 UVLED curing system), Heraeus Noblelight, and Fusion UV. Non-limiting examples of UV-emitting light bulbs include mercury bulbs (H bulbs), or metal halide doped mercury bulbs (D bulbs, H+ bulbs, and V bulbs). Other combinations of metal halides to create a UV light source are also contemplated. Exemplary bulbs could also be produced by assembling the lamp out of UV-absorbing materials and considered as a filtered UV source. An H bulb has strong output in the range of 200 nanometers (nm) to 320 nm. The D bulb has strong output in the 320 nm to 400 nm range. The V bulb has strong output in the 400 nm to 420 nm range.

It can also be advantageous to use a UV light source where the harmful wavelengths (those that cause polymer degradation or excessive yellowing) are removed or not present. Equipment suppliers such as Excelitas, Heraeus Noblelight, and Fusion UV provide lamps with various spectral distributions. The light can also be filtered to remove harmful or unwanted wavelengths of light. This can be done with optical filters that are used to selectively transmit or reject a wavelength or range of wavelengths. These filters are commercially available from a variety of companies such as Edmund Optics or Praezisions Glas & Optik GmbH. Bandpass filters are designed to transmit a portion of the spectrum, while rejecting all other wavelengths. Longpass edge filters are designed to transmit wavelengths greater than the cut-on wavelength of the filter. Shortpass edge filters are used to transmit wavelengths shorter than the cut-off wavelength of the filter. Various types of materials, such as borosilicate glass, can be used as a long pass filter. Schott and/or Praezisions Glas & Optik GmbH for example have the following long pass filters: WG225, WG280, WG295, WG305, WG320, which have cut-on wavelengths of ˜225, 280, 295, 305, and 320 nm, respectively. These filters can be used to screen out the harmful short wavelengths while transmitting the appropriate wavelengths for the crosslinking reaction. An exemplary lamp is a high pressure 200 watt mercury vapor short arc, used in combination with a light guide. A filter and an adjustable spot collimating adapter (for spreading the light beam over a large surface) can also be used. Of course, protective equipment to protect the user can also be used.

In particular embodiments, the coating layer is exposed to light that includes UVA light wavelengths with an intensity of 30.5 milliwatts per centimeter squared (mW/cm²) at a distance of 23 centimeters (cm) from the light source. UVA refers to wavelengths from 320 to 390 nm. This irradiation can be accomplished using a Collimated EXFO OMNICURE™ S2000 lamp.

At step S200 of FIG. 1, the methods ends with a substrate having a one or more surface areas covered with a LC coating. The substrate and the LC coating can subsequently be cleaned. The resulting coating containing liquid crystalline polymer can have a thickness of about 10 micrometers to about 20 micrometers (μm), though other thicknesses can be made. In particular embodiments, the LC coating can have an adhesion rating of GT-0 as measured by ASTM 3359-09, 2010 footnotes included or ISO 2409:2007(E). The typical test protocol involves three steps: (1) making a pattern of scratches in the coating and the substrate; (2) pressing a strong adhesive tape on the scratched part; and then (3) removing the adhesive tape completely in a single, fast movement. The pattern of scratches is formed from multiple parallel and perpendicular scratches. The parallel scratches are separated by a distance of about 3 mm, and should go through the coating layer AND part of the substrate. The adhesive tape can be TESA™ 4651 textile tape. Depending on the adhesion between the substrate and the coating, the entire coating, or only part of it, will be removed from the substrate by the tape. Accordingly, adhesion of the coating to the substrate is classified by a GT-# scale, running from GT-0 (being perfect adhesion) to GT-5 (no adhesion, complete removal of the coating).

The methods described herein can be performed without pre-activating the surface of the substrate, treating the surface of the substrate with other substances prior to applying the primer layer or the coating layer (e.g. plasma treatment, or acid/base application, or coating with a thin layer of a hydrogen-rich material like polydopamine or polyphenols); or post-polymerization purification steps.

It should be noted that the primer layer and the LC coating layer are applied directly to the substrate, without pre-treatment aiming at influencing the LC alignment or without using a so-called alignment layer. The latter is commonly used in the industry, and is usually done by applying a polyimide (PI) layer to the substrate, which is subsequently rubbed with a soft fabric to scratch the PI layer, and subsequently applying the liquid crystalline coating to the PI layer. The scratches act as a template for orientation of the liquid crystalline polymers in a particular direction. In the present disclosure, the LC orientation can be induced by shear during their deposition upon the substrate (e.g. with a doctor blade, using a slot die, or other spreading mechanism).

In particular embodiments of the present disclosure, the substrate upon which the liquid crystalline polymer coating is formed is a polymeric substrate. The substrate can comprise a polycarbonate or a blend containing a polycarbonate, e.g. LEXAN™ 8040. Other suitable substrates can include polymethyl methacrylate (PMMA); polyesters such as polyethylene terephthalate (PET); polycarbonate copolymers such as polycarbonate-polysiloxane copolymers or LEXAN™ CFR; and polyolefins. The substrate can comprise a poly(methyl methacrylate)-poly(ethyl acrylate) copolymer. The substrate can comprise polycarbonate and an acrylonitrile-butadiene-styrene (ABS) copolymer. Generally, the substrate has hydrogen atoms at its surface that can be extracted.

The substrate can be in the form of a molded article, a sheet, or a film. The substrate can be formed by a variety of known processes, such as casting, profile extrusion, film and/or sheet extrusion, sheet-foam extrusion, injection molding, blow molding, thermoforming, and the like. The substrate itself can be a component of an article, such that the article comprises a substrate to be coated with a LC coating.

The primer layer 140 of FIG. 1 includes a Type II photoinitiator. When exposed to UV light, the Type II photoinitiator in the primer layer reacts with the surface 122 of the substrate to generate radicals that initiate the polymerization of the LC monomers in the coating layer. In particular embodiments, the Type II photoinitiator is a benzophenone, a thioxanthone, a xanthone, or a quinone.

Benzophenones are also known as diphenylmethanone, diphenylketone or benzoyl benzene. Benzophenones have the general structure of Formula (i):

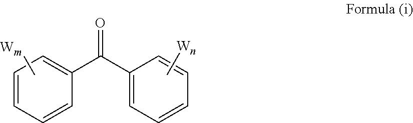

where each W is independently alkyl, carboxyl, hydroxyl, or amino; and m and n are independently integers from 0 to 2. Exemplary benzophenone Type II photoinitiators include benzophenone (m=n=0); 3,3′,4,4′-Benzophenonetetracarboxylic dianhydride (m=n=2); 4,4′-bis(diethylamino)benzophenone; 4,4′-bis(dimethylamino)benzophenone; 4,4′-dihydroxybenzophenone; 4-(dimethylamino)benzophenone; 2,5-dimethylbenzophenone (m=0, n=2); 3,4-dimethylbenzophenone (m=0, n=2); 3-hydroxybenzophenone (m=0, n=1); 4-hydroxybenzophenone; 2-methylbenzophenone; and 3-methylbenzophenone.

Thioxanthones and xanthones are compounds that contain a structure of Formula (ii):

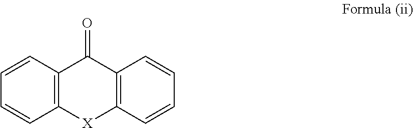

wherein X is sulfur or oxygen. The thioxanthone/xanthone can have substituents such as alkyl; halogen; and alkoxy. Exemplary thioxanthone Type II photoinitiators include thioxanthone; 1-chloro-4-propoxythioxanthone; 2-chlorothioxanthone; 2,4-diethylthioxanthone; 2-isopropylthioxanthone; 4-isopropylthioxanthone; and 2-mercaptothioxanthone.

Quinones generally have a fully conjugated cyclic dione structure. Exemplary quinone Type II photoinitiators include anthraquinone; anthraquinone-2-sulfonic acid; camphorquinone; 2-ethylanthraquinone; and phenanthrenequinone.

The primer layer 140 can be formed by dissolving an amount of the Type II photoinitiator in a solvent to form a priming solution. Generally, the solvent should dissolve the Type II photoinitiator and not degrade the substrate. In particular embodiments, the solvent may be an alcohol, such as ethanol; benzophenone; or an alkane. In some embodiments, the priming solution comprises from about 0.001 wt % to about 20 wt % of the Type II photoinitiator based on the total weight of the priming solution. In more particular embodiments, the priming solution comprises from about 5 wt % to about 15 wt % of the Type II photoinitiator based on the total weight of the priming solution. In still further embodiments, the priming solution comprises about 10 wt % of the Type II photoinitiator based on the total weight of the priming solution. The priming solution is applied to the surface area, and the solvent is then evaporated. The primer layer can be considered to be formed upon application of the priming solution, so solvent may or may not be present in the primer layer.

Another way of considering the primer layer is in terms of the amount of photoinitiator per area. In other embodiments, the primer layer comprises from about 0.0025 grams to about 1 gram of the Type II photoinitiator per square centimeter of the first surface area of the substrate (i.e. the surface of the substrate to be grafted with LC monomers).

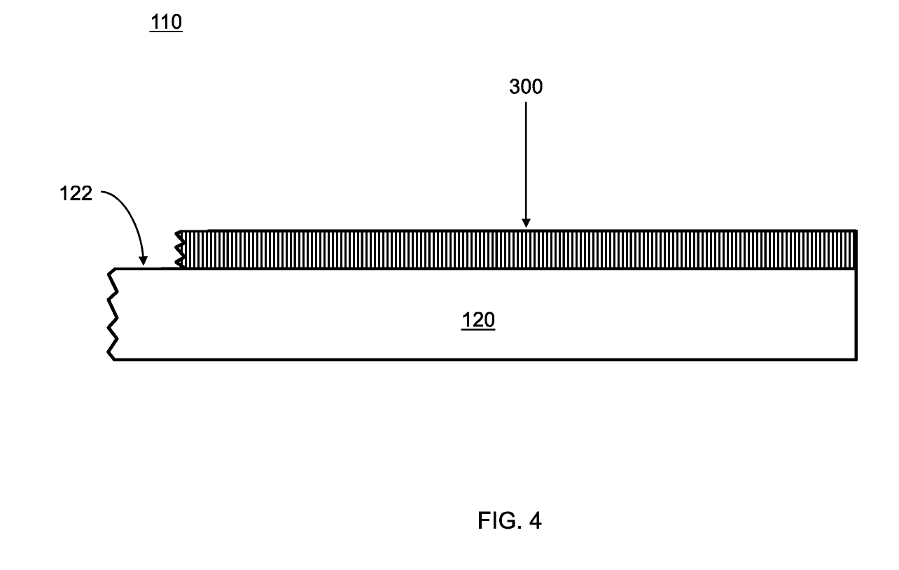

The coating mixture used to form the coating layer 150 contains at least one LC monomer. In particular embodiments as illustrated in FIG. 4, when exposed to UV light, the Type II photoinitiator in the primer layer 140 initiates polymerization of the LC monomers in the coating layer 150, forming a polymer matrix 300 containing a liquid crystalline polymer that is chemically bonded to the surface area of the substrate (i.e. chemisorption) of article 110.

If desired, the coating mixture can further comprise a second amount of a Type II photoinitiator, which can be the same as the Type II photoinitiator used in the primer layer.

In some embodiments, the LC monomer is a thermotropic LC monomer, containing at least a central rigid core, a reactive end group which takes part in polymerization, and a flexible spacer moiety between the central core (i.e. mesogenic unit) and the reactive end group. In particular, the rigid core or mesogen (Y), can comprise one or more aromatic groups. The identity of the spacer moiety determines the type of phase of the LC monomer (e.g. nematic or smectic); the transition temperatures between e.g. the isotropic and nematic phase; and the flexibility of the liquid crystal polymer network (and thus indirectly the mechanical properties and switching time of the liquid crystal polymer).

In particular embodiments, the LC monomer may be an acrylate LC monomer that has a terminal acrylate group. Such monomers have the structure of Formula (II):

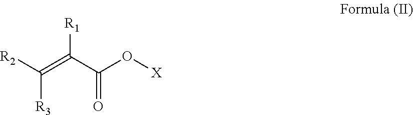

wherein R₁, R₂, and R₃ are each independently hydrogen, alkyl, or substituted alkyl; and X is a LC moiety.

In particular embodiments, the LC moiety X can comprise at least one mesogenic moiety Y and at least one spacer moiety Z (and usually more than one such moiety). For example, such LC moieties may have the structure of Formula (A):

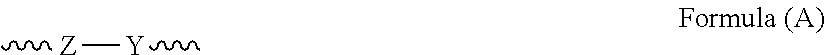

wherein Z and Y can be independently bound to at least another mesogenic moiety Y, spacer moiety Z, or a terminal group.

The combination of the spacer Z and mesogenic Y moieties gives the LC monomers an elongated (i.e. rod-like) shape responsible for the liquid crystalline behavior of the coating mixture.

In some embodiments, each spacer moiety Z may independently be a C₁-C₃₀ aliphatic group, a C₁-C₃₀ non-cyclic alkyl group, or a C₁-C₃₀ non-cyclic alkoxy group.

The mesogenic unit Y of the LC moiety X can comprise at least one aromatic group, which creates flat segments in the LC monomer. In particular embodiments, the mesogenic moiety Y can comprise one or more derivatives of p-hydroxybenzoic acid, having the structure of Formula (B):

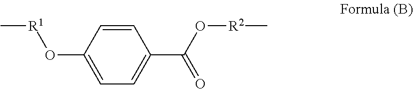

where R¹ and R² can independently be an aromatic group, —COO—, a heterocyclic or fused heterocyclic ring system, or a single bond.

In addition to one or more aromatic groups, the mesogenic moiety Y can further comprise one or more ester, ether, or carbonate linkages.

In particular embodiments, an LC monomer may comprise a LC moiety X comprising non-aromatic heterocyclic or fused heterocyclic ring systems (i.e. ring systems that do not have a delocalized pi system). The heterocyclic or fused heterocyclic ring systems may have heteroatoms such as nitrogen, sulfur, selenium, silicon, and oxygen. For example, a portion of the mesogen Y of LC moiety X can comprise a radical having the structure of Formula (C):

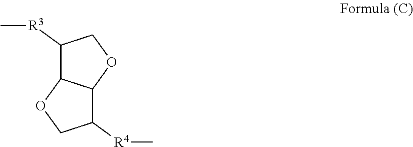

wherein R³ and R⁴ can independently be —COO— or an oxygen atom. The mesogen Y of LC moiety X can comprise a radical having the structure of Formula (C) located in between derivatives of p-hydroxybenzoic acid, for example, having the structure of Formula (B).

The LC monomer can comprise a chiral dopant such as chiral LC monomer having a chiral center. For example, a chiral LC monomer comprising a radical having the structure of Formula (C) is shown in Formula (1):

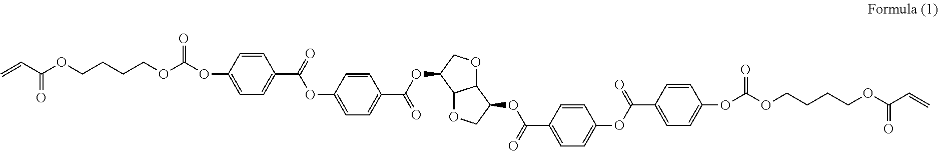 [SMILES: C=CC(=O)OCCCCOC(=O)Oc1ccc(C(=O)Oc2ccc(C(=O)O[C@H]3COC4C3OC[C@@H]4OC(=O)c3ccc(OC(=O)c4ccc(OC(=O)OCCCCOC(=O)C=C)cc4)cc3)cc2)cc1]

where the chirality is illustrated by the two bonds connecting the fused heterocyclic rings directed in the same direction out of the plane. It is noted that chirality can be altered by instead directing one of the bonds connecting the fused heterocyclic rings into the plane. It is further noted that the length of the spacer moieties, while illustrated as being 4 carbon atoms long, can be varied; and while the R₁, R₂, and R₃ groups are illustrated as being hydrogen atoms, they can be likewise be defined by the definition provided above. Likewise, the derivatives of p-hydroxybenzoic acid on either side of the fused heterocyclic rings can be altered.

The chirality can likewise be altered by adding a pendent group having a chiral center to the LC monomer, for example, to the spacer moiety. An example of a chiral LC monomer has the structure of Formula (W-1):

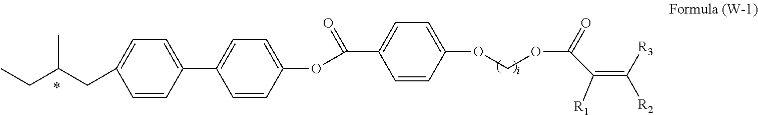

where R₁, R₂, and R₃ are defined above and i is an integer 1 to 10.

Examples of chiral LC monomers having a pendent group on the spacer moiety include those of the structure of Formula (W-2) and Formula (W-3):

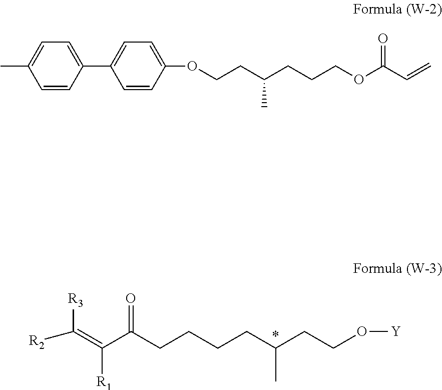

where R₁, R₂, R₃, and Y are defined above. It is noted that the chain length of the spacer and the location of the chiral center can be varied and is not limited to the examples of Formula (W-2) or Formula (W-3). Likewise, the chiral LC monomers can be bifunctional monomers having a chiral center located on each of the spacer moieties.

In addition to or instead of the chiral LC monomers, chirality can be incorporated into the coating by adding a chiral dopant that is the chiral LC monomer, such as a chiral molecule. Non-limiting examples of chiral molecules include those of Formulas (W4)-(W6):

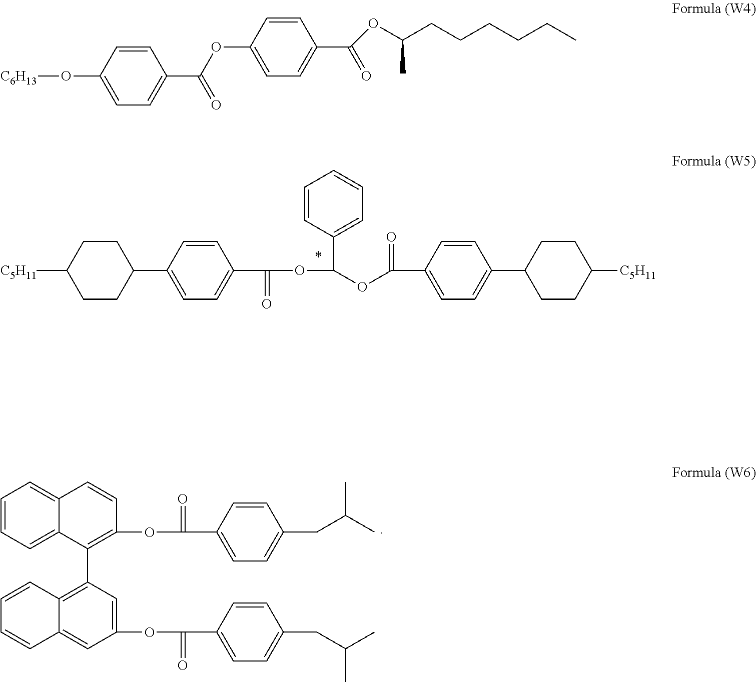

In further embodiments, the LC monomer can comprise a polyfunctional monomer having at least two terminal acrylate groups. An example of such LC monomers includes monomers having the structure of Formula (III):

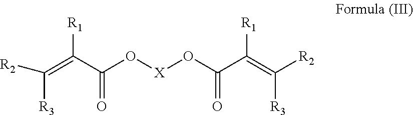

wherein R₁, R₂, and R₃ are defined above and X is a LC moiety. In an embodiment, R₁, R₂, and R₃ are each hydrogen.

In an embodiment, the polyfunctional monomer having at least two terminal acrylate groups can have the formula (III-A):

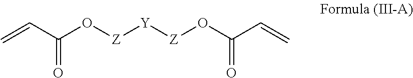

where each spacer moiety Z independently, R₁, R₂, R₃, and mesogenic moiety Y are defined above. In an embodiment, each spacer moiety Z is the same. Without being bound by theory, it is believed that the spacer moieties Z being the same can beneficially result in an improved crystalline nature of the liquid crystalline coating, facilitating the crystalline stacking of the mesogenic moiety Y of neighboring LC monomers.

In another embodiment, the polyfunctional monomer can have the formula (III-B):

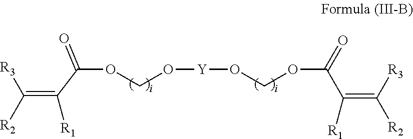

where i in both instances is the same or different integer 1 to 10. In an embodiment, i in both instances is the same integer 1 to 10. For example, the polyfunctional monomer of the Formula (III-B) can be a polyfunctional monomer of the Formula (III-C), where R₁, R₂, and R₃ are illustrated as being hydrogen:

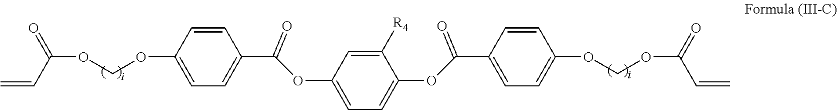

where R₄ is hydrogen, alkyl, or substituted alkyl and i in both instances is the same integer 1 to 10. For example, R₄ can be a methyl group and i in both instances can be 3; R₄ can be a methyl group and i in both instances can be 6; R₄ can be hydrogen and i in both instances can be 6; R₄ can be hydrogen and i in both instances can be 3; R₄ can be a hexyl group and i in both instances can be 6. It is noted that the length of the R₄ group can be adjusted to tune the properties of the liquid crystalline coating, for example, resulting in an increase or decrease in the transition temperature between the nematic and isotropic phases.

The polyfunctional monomer can comprise a light-responsive monomer. In an embodiment, the polyfunctional, light-responsive monomer can have the structure of Formula (III-B), where the mesogenic moiety Y comprises an azo group. For example, polyfunctional, light-responsive monomer can have the structure of Formula (III-D):

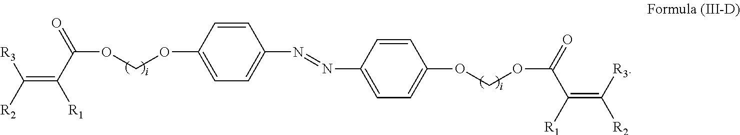

In Formula (III-D), R₁ can be a methyl group, R₂ and R₃ can be hydrogen, and i can be 3.

In other embodiments, the LC monomer can have at least one terminal nitrile group. Such LC monomers generally have the structure of Formula (IV):

R⁵—C≡N Formula (IV)

wherein R⁵ comprises a LC moiety X and at least one other terminal group.

In still further embodiments, the LC monomer can have at least one terminal methoxy group. Such LC monomers have the structure of Formula (V):

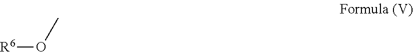

wherein R⁶ comprises a LC moiety X and at least one other terminal group.

Some non-limiting examples of specific LC monomers include those of Formulas (1)-(10).

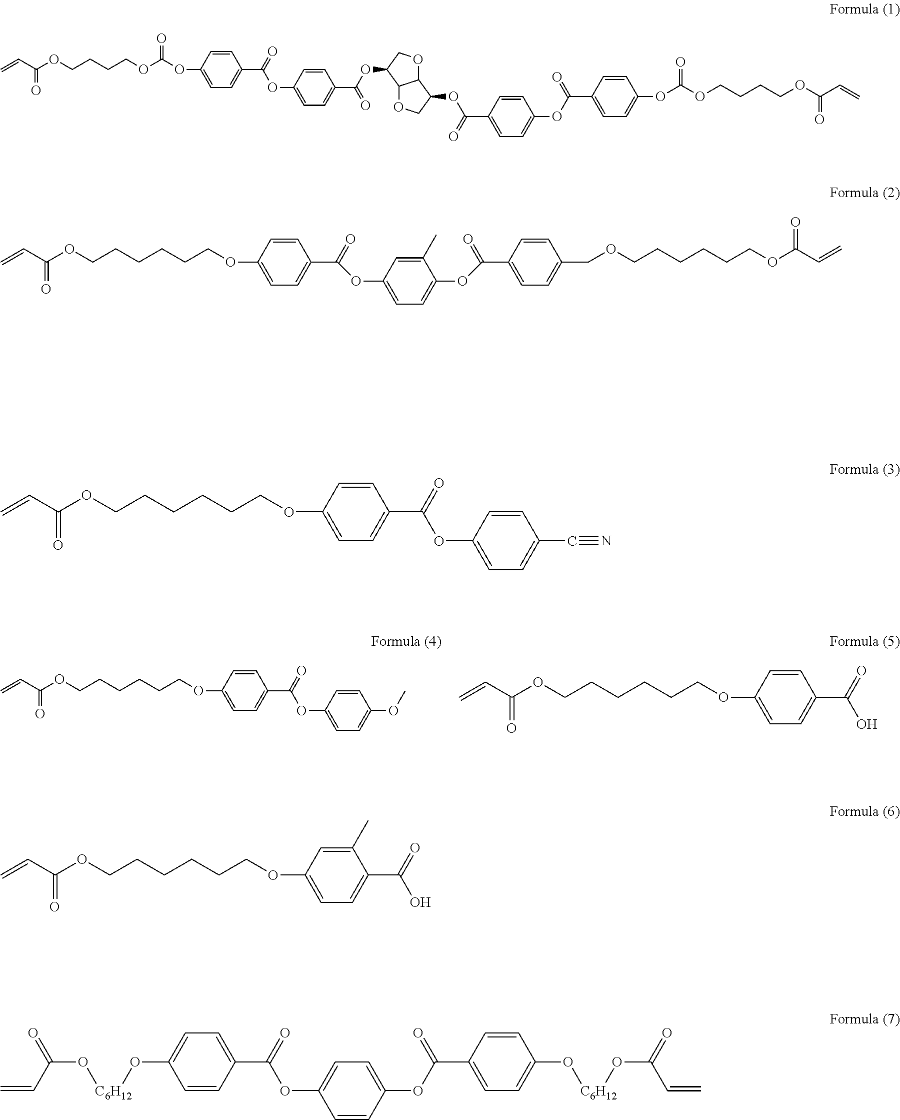

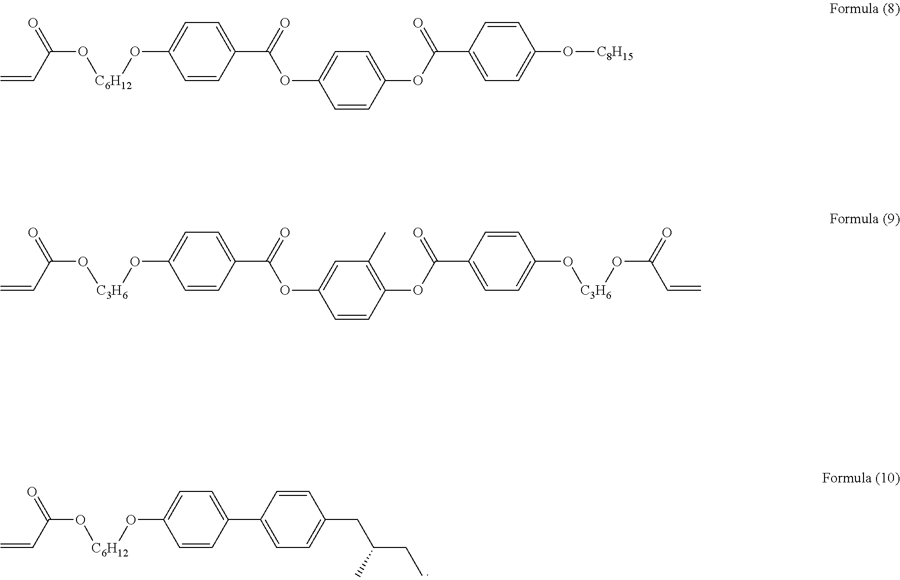

It is noted that while the structures of Formula (5) and Formula (6) themselves individually are not LC monomers, two of the molecules together can form hydrogen bonds via their carboxylic acid groups and the resultant structure forms the LC monomer.

The coating mixtures disclosed herein can comprise from about 70 wt % to about 100 wt %, or about 90 wt % to 100 wt % of LC monomers (by solids). In particular embodiments, the coating mixture can also comprise from about 1 wt % to about 10 wt % of a second photoinitiator (by solids), which can be the same as, or different from, the photoinitiator used in the priming solution/primer layer. The coating mixture can also comprise from about 0.5 wt % to about 5 wt % of a surfactant (by solids). An exemplary surfactant is 2-(N-ethylperfluorooctanesulfonamido) ethyl methacrylate.

Very generally, the coating mixture can contain a single LC monomer, or can comprise a plurality of LC monomers, i.e. each LC monomer can be present in an amount from about 1 wt % to 100 wt % of the coating mixture (by solids). The relative amounts and ratios of LC monomers in the coating mixture adjusted in order to tune properties like the nematic-isotropic phase transition temperature (T_{NI}), the degree of cross-linking, viscosity, response to specific stimuli, and/or the helix pitch of the cholesteric liquid crystalline polymer.

Generally, at least one polyfunctional monomer is present for cross-linking to occur, for example a monomer of Formula (1), (2), (7), or (9). Bifunctional monomers, such as a monomer of Formula (3), (4), (5), (6), (8), or (10) are used to obtain a specific degree of cross-linking and/or to tune the T_{NI}. Chiral dopants, such as the monomer of Formula (1), are used to obtain cholesteric LC coatings.

A bifunctional monomer has the general structure: reactive end group-spacer-LC moiety-non-reactive end group (i.e. the end groups are different).

A polyfunctional monomer has the following general structure: first reactive end group-first spacer-LC moiety-second spacer-second reactive end group.

A chiral dopant has the following general structure: first reactive end group-first spacer-first LC moiety-chiral element-second LC moiety-second spacer-second reactive end group.

In the monomers and dopants used herein, the reactive end groups are acrylates, such as methacrylates, and combinations thereof.

In some specific embodiments, the coating mixture can comprise from about 1 wt % to about 5 wt % of a LC monomer having the structure of Formula (1), from about 10 wt % to about 30 wt % of a LC monomer having the structure of Formula (2), from about 20 wt % to about 40 wt % of a LC monomer having the structure of Formula (3), and from about 30 wt % to about 50 wt % of a LC monomer having the structure of Formula (4), all based on the total weight of the LC monomer.

In other specific embodiments, the coating mixture can comprise from about 5 wt % to about 20 wt % of a LC monomer having the structure of Formula (2), from about 30 wt % to about 40 wt % of a LC monomer having the structure of Formula (4), from about 1 wt % to about 10 wt % of a LC monomer having the structure of Formula (1), from about 15 wt % to about 25 wt % of a LC monomer having the structure of Formula (5), and from about 15 wt % to about 25 wt % of a LC monomer having the structure of Formula (6), all based on the total weight of the LC monomer.

In yet other specific embodiments, the coating mixture can comprise from about 20 wt % to about 40 wt % of a LC monomer having the structure of Formula (7), from about 30 wt % to about 50 wt % of a LC monomer having the structure of Formula (8), and from about 25 wt % to about 35 wt % of a LC monomer having the structure of Formula (4), all based on the total weight of the LC monomer.

In still some further embodiments, the coating mixture can comprise from about 25 wt % to about 45 wt % of a LC monomer having the structure of Formula (9), from about 30 wt % to about 50 wt % of a LC monomer having the structure of Formula (10), and from about 25 wt % to about 35 wt % of a LC monomer having the structure of Formula (4), all based on the total weight of the LC monomer.

In particular embodiments, the coating layers disclosed herein can have an isotropic to nematic phase transition temperature of between 40° C. and 60° C. In an isotropic phase (i.e. liquid phase), the coating layer has no orientational order. However, in further embodiments, the coating layer can maintain a nematic phase at room temperature. In the nematic phase, the liquid crystalline polymers formed can exhibit long-range orientational order (i.e. the long axes of the LC monomers tend to align along a preferred direction), although the locally preferred direction can vary throughout the coating layer 150.

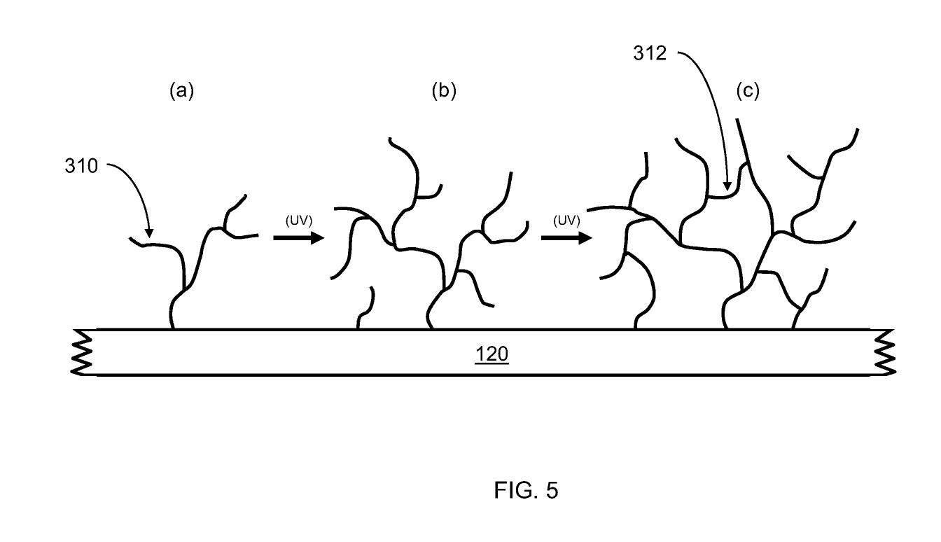

FIG. 5 is a diagram illustrating the formation of the LC coating 300 as the primer layer 140 and coating layer 150 are irradiated as in step S160. Initial exposure to light causes LC monomer chains 310 to covalently bond to radicals initiated from the surface area 122 of the substrate. As the exposure to UV radiation continues, additional LC monomer chains 310 bind to the surface, the LC monomer chains 310 grow, and depending on the LC monomers used, crosslinked chains 312 may form. Thus, the polymer matrix forming the LC coating is thereby chemically attached to the substrate.

As mentioned above, the liquid crystalline coating can be formed from more than one layer. This can be done by sequentially applying another primer layer to a first liquid crystalline layer to abstract hydrogen atoms from the first liquid crystalline layer. After the solvent has evaporated, a second coating layer is applied, and then irradiated to form a second liquid crystalline layer. In this way, multiple liquid crystalline layers can be built up.

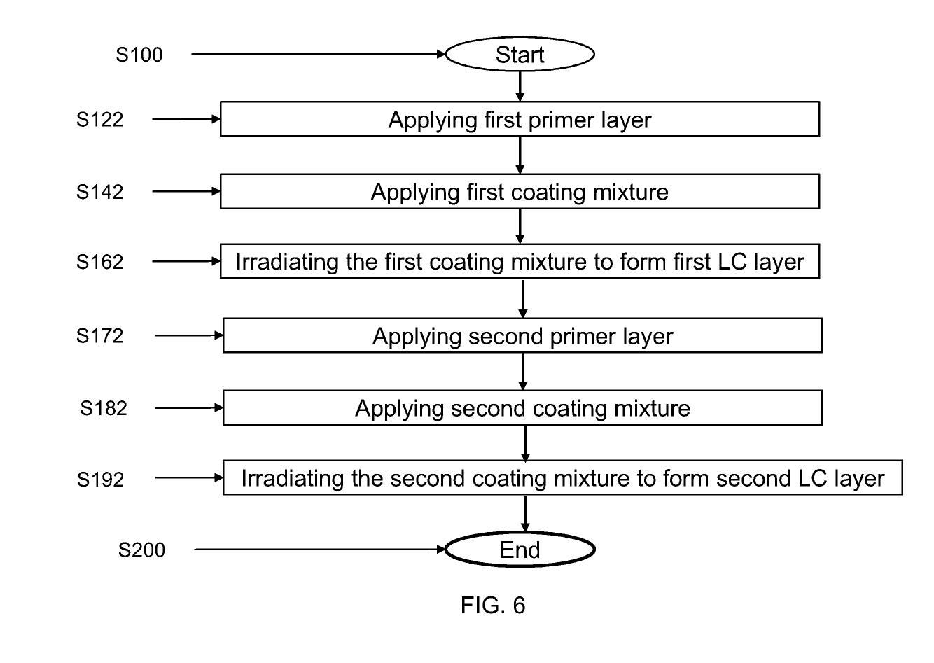

An exemplary method of building a liquid crystalline coating from two layers is illustrated in FIG. 6. This method is very similar to that of FIG. 1, and the previous discussion also applies here. This two-layer coating can be useful for certain applications such as infra-red reflection.

The method begins at step S100. At step S122, a first priming solution is applied to the first surface area of a substrate to form a first primer layer. Again, the first surface area can be only a portion of a given surface on the substrate. The first priming solution can sit on the surface of the substrate for a period of time to allow the solvent to evaporate. At step S142, a first coating mixture is applied to the first surface area of the substrate, or put another way upon the first primer layer, to form the first coating layer. At step S162, the first primer layer and the first coating mixture are irradiated to form a first liquid crystalline (LC) layer.

At step S172, a second priming solution is applied to the first LC layer to form a second primer layer. The second priming solution does not have to be applied to the entirety of the first LC layer unless it is desired to do so. The second priming solution can sit on the surface of the first LC layer for a period of time to allow the solvent to evaporate. The first priming solution and the second priming solution can be the same, or different.

At step S182, a second coating mixture is applied to the first LC layer, or put another way upon the second primer layer, to form the second coating layer. The first coating mixture and the second coating mixture can be the same, or different.

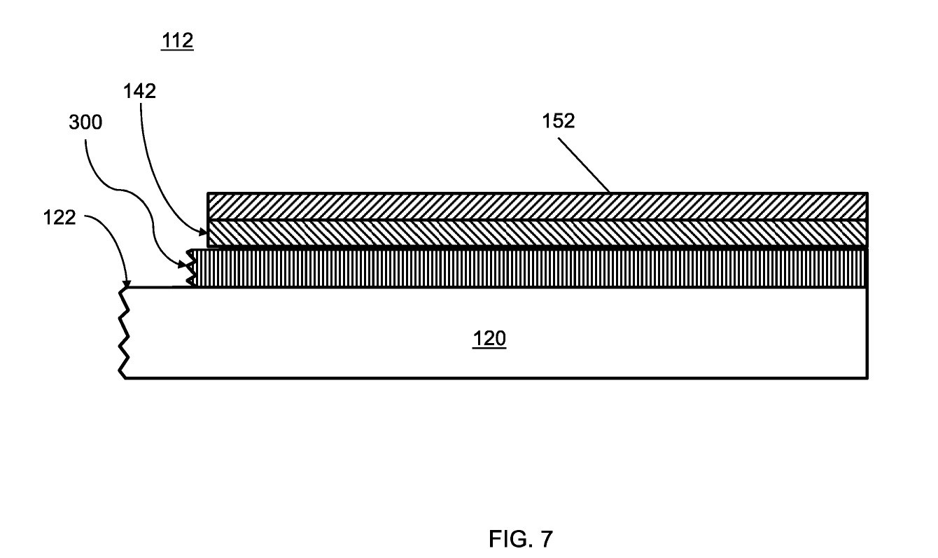

FIG. 7 illustrates the second method as of step S182. An article 112 is shown with a substrate 120 having a first liquid crystalline layer 300 on first surface area 122 thereof. The second primer layer 142 is shown upon the first liquid crystalline layer 300, and the second coating layer 152 is present upon the second primer layer 142.

At step S192, the second primer layer and the second coating mixture are irradiated to form a second liquid crystalline (LC) layer. The first LC layer and the second LC layer together form a liquid crystalline coating. It is noted that the application of the second primer layer causes abstraction of hydrogen atoms from the first LC layer, so the second LC layer is covalently bonded (i.e. chemisorbed) to the first LC layer and through the LC layer to the substrate. The method ends at step S200.

The following examples are provided to illustrate the coatings and methods of the present disclosure. The examples are merely illustrative and are not intended to limit the disclosure to the materials, conditions, or process parameters set forth therein.

### EXAMPLES

A preliminary analysis was performed to evaluate the adhesiveness of LC coatings formed by the methods disclosed herein. The substrates used were a polycarbonate homopolymer film (designated PC-1) cut into pieces of approximately 10 centimeters (cm) by 10 cm by 500 micrometers (length by width by thickness). Photopolymerization of the LC coating mixture was initiated using UV irradiation by a Collimated EXFO OMNICURE™ S2000 lamp, emitting UVA light with an intensity of 30.5 mW/cm² at a distance of 23 cm from the lamp. The chemical structures of the LC monomers are shown in Table 1. Formulations of the various LCP coatings are shown in Table 2 (wt % by solids). A summary of the results of each example is shown in Table 3. In some examples, a priming solution of benzophenone dissolved in ethanol (10 wt % by solids) was used. The details of each example follow.

TABLE 1
Composition of LC monomers used in Examples

| LC | | |
|---|---|---|
| Monomer | Formula | Structure |
| LC756 | Formula (1) | 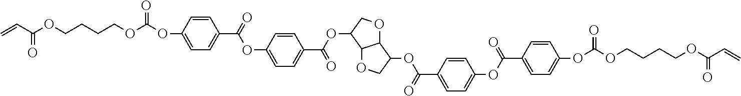 [SMILES: C=CC(=O)OCCCCOC(=O)Oc1ccc(C(=O)Oc2ccc(C(=O)OC3COC4C(OC(=O)c5ccc(OC(=O)c6ccc(OC(=O)OCCCCOC(=O)C=C)cc6)cc5)COC34)cc2)cc1] |
| RM82 | Formula (2) | 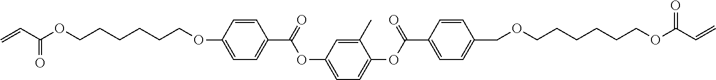 |
| RM32 | Formula (3) | 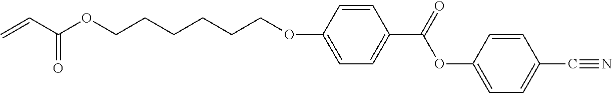 |
| RM105 | Formula (4) | 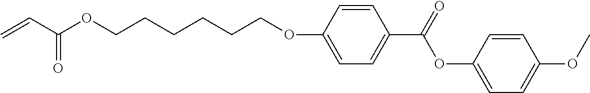 |
| 6OBA | Formula (5) | 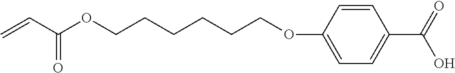 [SMILES: C=CC(=O)OCCCCCCOc1ccc(C(=O)O)cc1] |
| 6OBAM | Formula (6) | 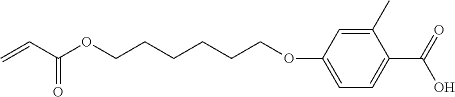 [SMILES: C=CC(=O)OCCCCCCOc1ccc(C(=O)O)c(C)c1] |
| DB162 | Formula (7) | 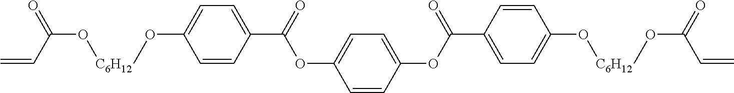 |
| DB335 | Formula (8) | 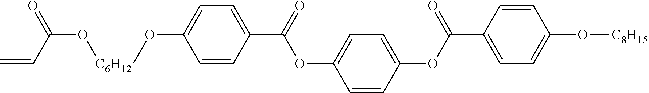 |
| RM257 | Formula (9) | 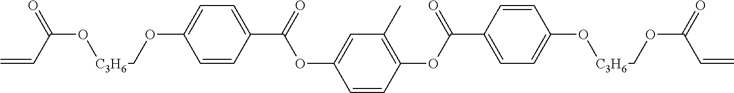 |
| RM96 | Formula (10) | 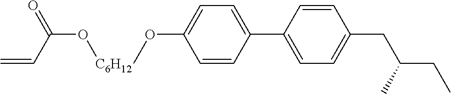 |

TABLE 2
Formulations of LCP coating mixtures

| | Formulation ID | | | | | | | |
|---|---|---|---|---|---|---|---|---|
| | A | B | C | D | E | F1 | F2 | G |
| Monomer/Photoinitiator | [wt %] | [wt %] | [wt %] | [wt %] | [wt %] | [wt %] | [wt %] | [wt %] |
| LC756 | 3.4 | 3.4 | 3.2 | 3.4 | 4.5 | — | — | 3.5 |
| RM82 | 19.3 | 19.2 | 17.6 | 19.2 | 13 | — | — | 20 |
| RM32 | 32.0 | 31.8 | 29.2 | 31.8 | — | — | — | 31.5 |
| RM105 | 43.8 | 43.6 | 40.0 | 43.6 | 37 | 31 | 28 | 43 |
| 6OBA | — | — | — | — | 21.5 | — | — | — |
| 6OBAM | — | — | — | — | 21.5 | — | — | — |
| DB162 | — | — | — | — | — | 28 | — | — |
| DB335 | — | — | — | — | — | 40 | — | — |
| RM257 | — | — | — | — | — | — | 36 | — |
| RM96 | — | — | — | — | — | — | 35 | — |
| IRGACURE ™ 819 | 1.5 | — | — | — | — | — | — | — |
| Benzophenone (BP) | — | 2.0 | 10.0 | 2.0 | 1.5 | 1 | 1 | — |
| 2-(N-Ethylperfluoro- | — | — | — | — | 1 | — | 1 | — |
| octanesulfonamido) | | | | | | | | |
| ethyl methacrylate | | | | | | | | |
| (surfactant) | | | | | | | | |

TABLE 3
Summary of Results

| | Comparative Examples | | | | Inventive Examples | | | |
|---|---|---|---|---|---|---|---|---|
| | 1 | 2 | 3 | 4 | 1 | 2 | 3 | 4 |
| Formulation | A | B | C | A | D | D | E | F1/F2 |
| Photoinitiator | IRGACURE ™ | BP | BP | IRGACURE ™ | BP | BP | BP | BP |
| | 819 | | | 819 | | | | |
| Photoinitiator | 1.5 | 1.0 | 10.0 | 1.5 | 2.0 | 2.0 | 1.5 | 1.0 |
| Content [wt %] | | | | | | | | |
| BP Primer Layer | No | No | No | Yes | Yes | Yes | Yes | Yes |
| Cross-Hatch Test | GT-5 | GT-5 | GT-5 | GT-5 | GT-0 | GT-0 | — | GT-0 |
| Rating | | | | | | | | |

### Comparative Example 1

LCP coating formulation A was placed onto a polycarbonate film (PC-1) at ambient temperature using a glass pipette. The coating mixture was spread using a casting bar with a die gap of 60 μm. Subsequently, the substrate was taped onto a glass plate and placed in an irradiation chamber for UV irradiation to start polymerization of the LCP coating. The irradiation was performed for 300 seconds, during which time, the sample was placed upside-down (i.e. the polycarbonate-side facing the light) and kept under a continuous nitrogen flow.

The resulting LCP coating layer had a reddish color. The surface coverage and thickness were not quantified, but the coating appeared homogenous. However, the LCP coating was almost entirely removed by the adhesive tape, and therefore failed the cross-hatch test at GT-5 rating as measured by ASTM 3359 or ISO 2409:2007(E). Thus, with no benzophenone, adhesion was poor.

### Comparative Example 2

LCP coating formulation B was placed onto a polycarbonate film (PC-1) at ambient temperature using a glass pipette. The coating mixture was spread using a casting bar with a die gap of 60 micrometers. Subsequently, the substrate was taped onto a glass plate and placed in an irradiation chamber for UV irradiation to start polymerization of the LCP coating. The irradiation was performed for 300 seconds, during which time, the sample was placed upside-down (i.e. the polycarbonate-side facing the light) and kept under a continuous nitrogen flow.

The resulting LCP coating layer had a reddish color. The surface coverage and thickness were not quantified, but the coating appeared homogenous. However, the LCP coating was almost entirely removed by the adhesive tape, and therefore failed the cross-hatch test at GT-5 rating as measured by ASTM 3359 or ISO 2409:2007(E). The removed coating showed good integrity on the adhesive tape (i.e. the photopolymerization using benzophenone as an initiator worked well in the bulk of the LCP coating mixture), but no adhesion of the LCP coating to the PC substrate was achieved. It is believed that this is because the effective concentration of the benzophenone at the substrate-coating interface was too low.

### Comparative Example 3

LCP coating formulation C (10% BP) was placed onto a polycarbonate film (PC-1) at ambient temperature using a glass pipette. The coating mixture was spread using a casting bar with a die gap of 60 micrometers. Subsequently, the substrate was taped onto a glass plate and placed in an irradiation chamber for UV irradiation to start polymerization of the LCP coating. The irradiation was performed for 300 seconds, during which time, the sample was placed upside-down (i.e. the polycarbonate-side facing the light) and kept under a continuous nitrogen flow.

The resulting LCP coating layer had a reddish color. The surface coverage and thickness were not quantified, but the coating appeared homogenous. Furthermore, the resulting LCP coating was stickier than the coatings in the other Examples. It is believed that the high content of the photoinitiator resulted in a large number of LCP chains with only a low degree of polymerization. The LCP coating was almost entirely removed by the adhesive tape, and therefore failed the cross-hatch test at GT-5 rating as measured by ASTM 3359 or ISO 2409:2007(E). The removed coating showed good integrity on the adhesive tape (i.e. the photopolymerization using benzophenone as an initiator worked well in the bulk of the LCP coating mixture), but no adhesion of the LCP coating to the PC substrate was achieved. It is believed that this is because the effective concentration of the benzophenone at the substrate-coating interface was too high.

### Inventive Example 1

Benzophenone(diphenylmethanone) was dissolved in ethanol at a concentration of 10 wt % of the priming solution 2 milliliters (mL) of this priming solution was spread over a polycarbonate (PC-1) substrate forming a primer layer, and was kept for a period of time at ambient temperature to allow for the evaporation of the ethanol.

Then, LCP coating formulation D was placed onto the substrate over the primer layer at ambient temperature using a glass pipette. The coating mixture was then spread using a casting bar with a die gap of 60 micrometers.

Subsequently, the substrate was taped onto a glass plate and placed in an irradiation chamber for UV irradiation to start polymerization of the LCP coating. The irradiation was performed for 300 seconds, during which time, the sample was placed upside-down (i.e. the polycarbonate-side facing the light) and kept under a continuous nitrogen flow.

The resulting LCP coating layer had a reddish color. The surface coverage and thickness were not quantified, but appeared homogenous. The coating layer remained entirely intact and adhered to the polycarbonate substrate after removal of the tape. Thus, the LCP coating passed the cross-hatch test at a rating of GT-0 as measured by ASTM 3359 or ISO 2409:2007(E).

### Comparative Example 4

Benzophenone was dissolved in ethanol at a concentration of 10 wt %. 2 milliliters of this primer solution was spread over a polycarbonate (PC-1) substrate forming a primer layer, and was kept for a period of time at ambient temperature to allow evaporation of the ethanol.

Then, LCP coating formulation A was placed onto the substrate over the primer layer at ambient temperature using a glass pipette. The coating mixture was then spread using a casting bar with a die gap of 60 micrometers.

Subsequently, the substrate was taped onto a glass plate and placed in an irradiation chamber for UV irradiation to start polymerization of the LCP coating. The irradiation was performed for 300 seconds, during which time, the sample was placed upside-down (i.e. the polycarbonate-side facing the light) and kept under a continuous nitrogen flow.

The resulting LCP coating layer had a reddish color (though this depends on the angle of incidence). The surface coverage and thickness were not quantified, but the coating appeared homogenous. However, the LCP coating was almost entirely removed by the adhesive tape, and therefore failed the cross-hatch test at GT-5 rating as measured by ASTM 3359 or ISO 2409:2007(E).

It is believed that the kinetics of photopolymerization of the LCP monomers using IRGACURE™ 819 as a photoinitiator in the coating mixture are so much faster than the initiation of the polymerization by benzophenone at the interface that no effective coupling between the substrate and the coating layer is achieved before all growing polymer chains in the bulk of the coating layer have been terminated. In other words, the use of the primer layer containing a Type II photoinitiator did not permit a Type I photoinitiator to be used in the coating mixture and still obtain chemisorption of the coating layer.

### Inventive Example 2

The Comparative Examples and Inventive Example 1 used PC-1 polycarbonate film as the substrate, the PC-1 film having a thickness of 500 micrometers (μm). Other plastic substrates were also tested using Formulation D and the same procedures and concentrations as listed in Inventive Example 1.

Four additional substrates were tested: PC-2; PC-3; Melinex 506™; and PC-4.

PC-2 is a polycarbonate that includes flame retardant (FR) agents. The PC-2 substrate had a thickness of 175 micrometers.

PC-3 is a polycarbonate that includes ultraviolet absorbing agents and does not contain FR agents. PC-3 is described in U.S. Pat. No. 7,459,259, and in U.S. Patent Publication Nos. 2013/0320276 and 2013/0323476, all of which are incorporated by reference in their entirety. The PC3 substrate had a thickness of 100 micrometers.

MELINEX 506™ is an optically clear knurled film made of polyethylene terephthalate (PET) with an adhesion promoting pretreatment on both surfaces. The MELINEX 506™ substrate had a thickness of 125 micrometers.

PC-4 is a coextruded film of polymethyl methacrylate (PMMA) and polycarbonate. The liquid crystalline coating was formed on the PMMA surface. The PC-4 substrate had a thickness of 250 micrometers.

GT-0 ratings were obtained on all four of the substrates tested.

### Inventive Example 3

PC-1 was cut into pieces of approximately 12 cm×6 cm. Gloves were worn to prevent fingerprints on the polycarbonate (PC) pieces. The PC pieces were cleaned with a nitrogen gas flow. Isopropanol or ethanol was used to clean the substrate if any fingerprints were visible, otherwise this cleaning step was avoided due to scratching of the substrate.

10 wt % benzophenone (BP) was dissolved in ethanol. A volume of 0.25 mL of the BP solution was placed on top of the heated substrate (40° C.) using a plastic Pasteur pipette. The substrate was covered by the mixture due to excellent wetting. The solvent was allowed to evaporate for approximately 15 minutes at 40° C.

Formulation E was heated to the isotropic phase at 70° C. and was allowed to mix homogenously. After mixing, the mixture was transferred with a Finn pipette with heated tip (70° C.) to the treated substrate. The mixture was allowed to cool rapidly to room temperature, in which the mixture undergoes a phase transition to the cholesteric phase. Subsequently, the mixture was coated using a doctor blade. After coating, the mixture was directly cured for 300 seconds at an intensity of 48 mW/cm² in the range of 320 nm to 390 nm (UVA). The coating was submerged in a 1 molar (M) KOH solution after which the properties of the coating were analyzed.

The coating was reddish (top view) and lost its color when it was brought in contact with water. When heated from room temperature to 70° C., the coating became green. Both color changes were reversible. This indicates the coating could be used as a water sensor, i.e. as a stimuli-responsive coating.

### Inventive Example 4

PC-1 was cut into pieces of approximately 12 cm×6 cm. Gloves were worn to prevent fingerprints on the polycarbonate (PC) pieces. The PC pieces were cleaned with a nitrogen gas flow. Isopropanol or ethanol was used to clean the substrate if any fingerprints were visible, otherwise this cleaning step was avoided due to scratching of the substrate.

10 wt % benzophenone (BP) was dissolved in ethanol. A volume of 0.25 mL of the BP solution was placed on top of the heated substrate (40° C.) using a plastic Pasteur pipette. The substrate was covered by the mixture due to excellent wetting. The solvent was allowed to evaporate for approximately 15 minutes at 40° C.

Formulation F1 was heated to 90° C. and allowed to mix for a while. Afterwards the mixture was transferred with a Finn pipette with heated tip (90° C.) to the substrate. The substrate and doctor blade were heated to approximately 60° C. to 70° C. to ensure that the formulation remained in a cholesteric phase. Subsequently, the coating was cured for 300 seconds with radiation having an intensity of 30.5 mW/cm² in the range of 320 nm to 390 nm (UVA). After curing this first coating, the sample was allowed to rest for several minutes.

Next, the substrate with the first coating was heated to 40° C. A second volume of 0.25 mL of the BP solution was placed on top of the first coating. The solvent was allowed to evaporate for approximately 15 minutes at 40° C.

Formulation F2 was heated to 90° C. and allowed to mix for a while. Afterwards, the mixture was transferred with a Finn pipette with heated tip (90° C.) and deposited upon the first coating (made from Formulation F1). At room temperature, the mixture was spread out using a doctor blade and directly cured for 300 seconds with radiation having an intensity of 30.5 mW/cm² in the range of 320 nm to 390 nm. This resulted in a substrate with two different coatings of liquid crystalline polymers. The multi-layer system had good adhesion. This multi-layer system is also believed to be suitable for reflecting infra-red light.

### Inventive Example 5

Benzophenone(diphenylmethanone) was dissolved in ethanol at a concentration of 10 wt % of the priming solution. 30 centimeter squared of various plastic materials as shown in Table 4 were heated to 40° C. wetted with 0.25 mL of this priming solution and was kept for 15 to 20 minutes at ambient temperature to allow for the evaporation of the ethanol.

TABLE 4
Summary of Substrate Materials

| Polymer | Description | Source |
|---|---|---|
| PMMA-EA | Poly(methyl methacrylate)-poly(ethyl acrylate) | Arkema |
| | copolymer | |
| PC-FR | XHR2000, Flame retardant polycarbonate | SABIC |
| PC/ABS | Cycoloy C1200HF, Polycarbonate | SABIC |
| | acrylonitrile-butadiene-styrene blend | |
| PC-HF | HF1110, High flow polycarbonate | SABIC |
| PC-HR1 | 8040DE, Heat resistant polycarbonate | SABIC |
| PC-HR2 | 8040T, Heat resistant polycarbonate | SABIC |

LCP coating formulation G was heated to a temperature of 40° C. and was placed onto the various substrates over the primer layer at ambient temperature using a plastic Pasteur pipette. The coating mixture was then spread on each substrate using a casting bar with a die gap of 60 micrometers.

Subsequently, each substrate was taped onto a glass plate and placed in an irradiation chamber for UV irradiation to start polymerization of the LCP coating using a UV light having an intensity of 30 mW/cm² in the range of 320 to 390 nm at a distance of 23 cm. The irradiation was performed for 300 seconds, during which time, each sample was placed upside-down (i.e. the polycarbonate-side facing the light) and kept under a continuous nitrogen flow.

The resulting LCP coating layers are described in Table 5, where ND stands for not determined.

TABLE 5
Summary of Results

| Substrate | Benzophenone | Cross-Hatch Test Rating |
|---|---|---|
| PMMA | Y | GT-0 |
| | N | GT0-GT5 |
| PC-FR | Y | GT-0 |
| | N | GT-0 |
| PC/ABS | Y | ND |
| | N | GT-0 |
| PC-HF | Y | GT-0 |
| | N | GT-5 |
| PC-HR1 | Y | GT-0 |
| | N | GT-5 |
| PC-HR2 | Y | GT-0 |
| | N | GT-5 |

Table 5 shows that the presence of the benzophenone in the coating mixture was able to increase the adhesion rating in several of the substrates. In all of the examples of Table 5, good wetting of the primer layer and coating layer was observed. The coating on the PMMA substrate resulted in some inhomogeneity. The alignment of coating on the PC-FR substrate was not as good as the alignment on the PC/ABS, PC-HF, PC-HR1, or PC-HR2 substrates.

Set forth below are non-limiting embodiments of the present disclosure.

### Embodiment 1

A method of grafting a liquid crystalline coating onto a substrate, the method comprising: applying a first primer layer comprising a Type II photoinitiator onto a first surface area of the substrate; applying a first coating layer comprising at least one liquid crystalline monomer onto the first surface area of the substrate; and irradiating the first coating layer to form a first liquid crystalline layer; wherein the liquid crystalline coating includes the first liquid crystalline layer.

### Embodiment 2

The method of embodiment 1, wherein alignment of the at least one liquid crystalline monomer in the first coating layer is induced by shear during application onto the first surface area of the substrate.

### Embodiment 3

The method of any one or more of the preceding embodiments, wherein the at least one liquid crystalline monomer is from about 70 wt % to 100 wt % of the first coating layer.

### Embodiment 4

The method of any one or more of the preceding embodiments, wherein the at least one liquid crystalline monomer in the first coating layer is a polyfunctional monomer.

### Embodiment 5

The method of any one or more of the preceding embodiments, wherein the at least one liquid crystalline monomer in the first coating layer further includes a bifunctional monomer or a chiral dopant.

### Embodiment 6

The method of any one or more of the preceding embodiments, wherein the irradiation penetrates to an interface of the first surface area of the substrate, the first primer layer, and the first coating layer.

### Embodiment 7

The method of any one or more of the preceding embodiments, wherein the at least one liquid crystalline monomer in the first coating layer comprises a structure of at least one of Formulas (1)-(10).

### Embodiment 8

The method of any one or more of the preceding embodiments, wherein the first primer layer is formed by dissolving the Type II photoinitiator in a solvent.

### Embodiment 9

The method of any one or more of the preceding embodiments, wherein the Type II photoinitiator of the first primer layer comprises at least one of a benzophenone, a thioxanthone, a xanthone, or a quinone.

### Embodiment 10

The method of any one or more of the preceding embodiments, wherein the first primer layer comprises from about 0.0025 grams to about 1 gram of the Type II photoinitiator per square-centimeter of the first surface area of the substrate.

### Embodiment 11

The method of any one or more of the preceding embodiments, wherein the first coating layer further comprises a second Type II photoinitiator, wherein (a) the second Type II photoinitiator is the same as the first Type II photoinitiator or (b) the second Type II photoinitiator is different from the first Type II photoinitiator.

### Embodiment 12

The method of embodiment 11, wherein the first coating layer comprises from about 1 wt % to about 10 wt % of the second Type II photoinitiator based on the total weight of the first coating layer.

### Embodiment 13

The method of any one or more of the preceding embodiments, wherein the first coating layer is irradiated by exposing the first coating layer to ultraviolet (UV) radiation through the substrate.

### Embodiment 14

The method of any one or more of the preceding embodiments, wherein the substrate has a surface with abstractable hydrogen atoms.

### Embodiment 15

The method of embodiment 14, wherein the substrate is a polymeric substrate.

### Embodiment 16

The method of any one or more of embodiments 14 to 15, wherein the substrate is transparent or flexible.

### Embodiment 17

The method of any one or more of embodiments 14 to 16, wherein the substrate comprises at least one of a polycarbonate, polymethyl methacrylate, polyethylene terephthalate, or a polyolefin.

### Embodiment 18

The method of any one or more of the preceding embodiments, further comprising: applying a second primer layer comprising a Type II photoinitiator onto the first liquid crystalline layer; applying a second coating layer comprising at least one liquid crystalline monomer onto the first liquid crystalline layer; and irradiating the second coating layer to form a second liquid crystalline layer; wherein the liquid crystalline coating includes the first liquid crystalline layer and the second liquid crystalline layer.

### Embodiment 19

The method of any one or more of the preceding embodiments, wherein the liquid crystalline coating has an adhesion rating of GT-0 as measured by ASTM 3359 or ISO 2409:2007(E).

### Embodiment 20

The method of any one or more of the preceding embodiments, wherein pre-activating the first surface area of the substrate, treating the first surface area of the substrate prior to applying the coating mixture, or post-polymerization purification are not performed.

### Embodiment 21

The article formed by the method of any one or more of embodiments 1-20.

### Embodiment 22

An article comprising a substrate having a liquid crystalline coating, wherein the liquid crystalline coating has an adhesion rating of GT-0 as measured by ASTM 3359 or ISO 2409:2007(E).

### Embodiment 23

The article of embodiment 22, wherein the liquid crystalline coating is formed by photografting a coating mixture comprising a plurality of liquid crystalline monomers onto the substrate using a Type II photoinitiator.

### Embodiment 24

A method of grafting liquid crystalline polymers onto a substrate, the method comprising: applying a first photoinitiator onto a first area of the substrate, wherein the first photoinitiator is a Type II photoinitiator; applying a first coating mixture comprising at least one liquid crystalline monomer onto the first area of the substrate so as to induce shear; and irradiating the coating mixture to form a liquid crystalline coating; wherein the liquid crystalline coating has an adhesion rating of GT-0 as measured by ASTM 3359 or ISO 2409:2007(E).

### Embodiment 25

The method of embodiment 24, wherein the applying comprises spreading the first coating mixture upon the first area with a doctor blade, or using a slot die to apply the first coating mixture upon the first area.

### Embodiment 26

A kit, comprising: a priming solution comprising a first Type II photoinitiator; and a coating mixture comprising at least one liquid crystalline monomer.

### Embodiment 27

The kit of embodiment 26, wherein the coating mixture further comprises a second Type II photoinitiator.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

Reference throughout the specification to “an embodiment”, “another embodiment”, and so forth, means that a particular element (e.g., feature, structure, step, or characteristic) described in connection with the embodiment is included in at least one embodiment described herein, and may or may not be present in other embodiments. In addition, the described elements may be combined in any suitable manner in the various embodiments.

Unless specified to the contrary herein, all test standards are the most recent standard in effect as of the filing date of this application, or, if priority is claimed, the filing date of the earliest priority application in which the test standard appears.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A method of grafting a liquid crystalline coating onto a substrate, the method comprising:
applying a first primer layer comprising a solution comprising 0.001 wt % to 20 wt % of a Type II photoinitiator based on the total weight of the solution and a solvent onto a first surface area of the substrate; wherein the Type II photoinitiator comprises at least one of a benzophenone, a thioxanthone, a xanthone, or a quinone and wherein the solvent comprises at least one of an alcohol or an alkane;
evaporating the solvent from the first primer layer;
after the evaporating, applying a first coating layer comprising at least one liquid crystalline monomer onto the first surface area of the substrate; and
irradiating the first coating layer to form a first liquid crystalline layer; wherein the liquid crystalline coating includes the first liquid crystalline layer.

2. The method of claim 1, wherein alignment of the at least one liquid crystalline monomer in the first coating layer is induced by shear during application onto the first surface area of the substrate.

3. The method of claim 1, wherein the at least one liquid crystalline monomer is from about 70 wt % to 100 wt % of the first coating layer.

4. The method of claim 1, wherein the at least one liquid crystalline monomer in the first coating layer is a polyfunctional monomer.

5. (canceled)

6. The method of claim 1, wherein the irradiation penetrates to an interface of the first surface area of the substrate, the first primer layer, and the first coating layer.

7. The method of claim 1, wherein the at least one liquid crystalline monomer in the first coating layer comprises a structure of at least one of Formulas (1)-(10).

8. (canceled)

9. (canceled)

10. The method of claim 1, wherein the first primer layer comprises from about 0.0025 grams to about 1 gram of the Type II photoinitiator per square-centimeter of the first surface area of the substrate.

11. The method of claim 1, wherein the first coating layer further comprises a second Type II photoinitiator, wherein (a) the second Type II photoinitiator is the same as the first Type II photoinitiator or (b) the second Type II photoinitiator is different from the first Type II photoinitiator.

12. The method of claim 11, wherein the first coating layer comprises from about 1 wt % to about 10 wt % of the second Type II photoinitiator based on the total weight of the first coating layer.

13. The method of claim 1, wherein the first coating layer is irradiated by exposing the first coating layer to ultraviolet (UV) radiation through the substrate.

14. The method of claim 1, wherein the substrate has a surface with abstractable hydrogen atoms.

15. The method of claim 14, wherein the substrate is a polymeric substrate.

16. (canceled)

17. The method of claim 14, wherein the substrate comprises at least one of a polycarbonate, polymethyl methacrylate, polyethylene terephthalate, or a polyolefin.

18. The method of claim 1, further comprising:
applying a second primer layer comprising a Type II photoinitiator onto the first liquid crystalline layer;
applying a second coating layer comprising at least one liquid crystalline monomer onto the first liquid crystalline layer; and
irradiating the second coating layer to form a second liquid crystalline layer;
wherein the liquid crystalline coating includes the first liquid crystalline layer and the second liquid crystalline layer.

19. The method of claim 1, wherein the liquid crystalline coating has an adhesion rating of GT-0 as measured by ASTM 3359 or ISO 2409:2007(E).

20. The method of claim 1, wherein pre-activating the first surface area of the substrate, treating the first surface area of the substrate prior to applying the coating mixture, or post-polymerization purification are not performed.

21. The article formed by the method of claim 1.

22. An article comprising a substrate having a liquid crystalline coating, wherein the liquid crystalline coating has an adhesion rating of GT-0 as measured by ASTM 3359 or ISO 2409:2007(E).

23. (canceled)

24. A method of grafting liquid crystalline polymers onto a substrate, the method comprising:
applying a solution comprising 0.001 wt % to 20 wt % of a first photoinitiator based on the total weight of the solution onto a first area of the substrate, wherein the first photoinitiator is a Type II photoinitiator comprising at least one of a benzophenone, a thioxanthone, a xanthone, or a quinone and wherein the solvent comprises at least one of an alcohol or an alkane;
evaporating the solvent in the first area of the substrate;
after the evaporating, applying a first coating mixture comprising at least one liquid crystalline monomer onto the first area of the substrate so as to induce shear; and
irradiating the coating mixture to form a liquid crystalline coating;
wherein the liquid crystalline coating has an adhesion rating of GT-0 as measured by ASTM 3359 or ISO 2409:2007(E).

25. The method of claim 24, wherein the applying comprises spreading the first coating mixture upon the first area with a doctor blade, or using a slot die to apply the first coating mixture upon the first area.
